(19) United States
(12) Patent Application Publication
(10) Pub. No.: US 2016/0221303 A1
(43) Pub. Date: Aug. 4, 2016

(54) MATERIAL FOR BALLISTIC PROTECTION, METHOD OF PREPARATION AND USE THEREOF

(71) Applicant: BRNO UNIVERSITY OF TECHNOLOGY, Brno (CZ)

(72) Inventors: Josef JANCAR, Brno - Kohoutovice (CZ); Jiri TOCHACEK, Brno - Zabovresky (CZ); Petr POLACEK, Slapanice (CZ); Frantisek KUCERA, Brno - Husovice (CZ); Lucy VOJTOVA, Menin (CZ)

(73) Assignee: BRNO UNIVERSITY OF TECHNOLOGY, Brno (CZ)

(21) Appl. No.: 14/917,309

(22) PCT Filed: Sep. 30, 2014
(86) PCT No.: PCT/CZ2014/000107

§ 371 Date: Mar. 8, 2016

(30) Foreign Application Priority Data
Sep. 30, 2013 (CZ) PUV 2013-28558
Sep. 30, 2013 (CZ) PV 2013-760

(51) Int. Cl. B32B 7/12; F41H 5/04; B32B 3/26; B32B 5/18; B32B 5/24; F41H 5/007; B32B 5/26

(52) U.S. Cl. CPC B32B 7/12; F41H 5/007; F41H 5/0471; B32B 5/26; B32B 5/18; B32B 5/245; B32B 3/266; B32B 2255/26; B32B 2255/02; B32B 2262/0253; B32B 2266/025; B32B 2307/56; B32B 2571/02

(57) ABSTRACT

A material for ballistic protection includes multiple compact layers of ballistic fiber and, between the layers of ballistic fibers, inserted at least one intermediate layer of non-Newtonian fluid exhibiting an increase in viscosity resulting from an increase in shear stress optionally containing particles having the size of from 1 to 700 nm or antiplasticizing agents. The intermediate layer is placed either directly between layers of ballistic fiber or between the layers on a packing or a perforated packing or applied on a fabric.

A method of preparation of the material is also disclosed. This material is flexible and has a low weight and can be used, in particular, for bulletproof vests, combat helmets, personal body armor and/or for shielding light infantry and passenger automobiles.

### FIELD OF INVENTION

The present invention relates to new ballistic and puncture protective materials, method of preparation and use thereof. Said materials are particularly suitable for bulletproof vests, combat helmets and personal body armor and for shielding light infantry and passenger automobiles, trucks and mobile command headquarters against ballistic threats.

### BACKGROUND ART

New improvements in the area of flexible ballistic protective materials and material combinations are being continually implemented in efforts to maintain contact with the development of ballistic technology. U.S. Pat. No. 3,841,954 discloses a laminated panel or plate formed from multiple layers of fabric, stitched together and compressed under heat and pressure, whereby a rigid panel is created for use as a component in personal body armor. U.S. Pat. No. 3,509,833 discloses a flexible armor of ceramic plates mounted on a backing of flexible, laminated fibers arranged slantwise in a cross-ply pattern. U.S. Pat. No. 4,522,871 and U.S. Pat. No. 4,781,351 propose a flexible armor containing multiple layers of woven polyaramid fibers, e.g., the material marketed under the trademark KEVLAR. U.S. Pat. No. 4,608,717 proposes a flexible armor comprising multiple layers of polyaramid fibers in combination with an intermediate layer of packed feathers, foam or felt material. The layers are stitched together to form an integral, flexible panel. U.S. Pat. No. 3,924,038 discloses a multi-layer panel suitable for a flack suit for pilots or as temporary cover for airplanes or equipment in a battle zone. The panel is designed to provide protection against shrapnel thrown by exploding ammunitions. The multi-layer panel comprises an inner cushion of nylon cloth and felt, an intermediate honeycomb spacer, and an outer protective layer of ceramic plates. The honeycomb spacer serves to rigidify the panel into an inflexible structure. U.S. Pat. No. 5,060,314 discloses a protective jacket made of flexible ballistic fabric and containing internal pockets for hard armor ballistic inserts. Additional shoulder pads have flotation cushions to provide buoyancy in water. U.S. Pat. No. 3,867,239, No. 4,198,707 and No. 4,633,756 disclose armor panels comprising plates that have undergone a process of hardening multiple times, arranged in numerous layers on a fabric backing. U.S. Pat. No. 7,825,045 discloses personal body armor made of polymeric fibers impregnated with a particle suspension in a fluid that exhibits shear thickening qualities (an increase in viscosity resulting from an increase in shear stress, a type of non-Newtonian fluid). Impregnation, however, brings certain limitations and, for example, restricts particle size and is not compatible with nanoparticles which increase the viscosity and thus prevent impregnation. Moreover, previous solutions utilize the creation of ordered structures resulting from the shear stress caused by high velocity impact. Dilatant fluid is a low-viscosity solution, most often in polyethylene glycol and containing a large quantity of solid particles. Another variation of the said system utilizes a combination of two types of molecules, the structure of which under conditions of low shear speed remains flexible, enabling free movement due to low molecular friction. At high speeds, however, there is a sharp increase in the said molecular friction, leading to a dilatant rheological response.

Hitherto known materials for ballistic protection are high in weight and mass and lacking in flexibility, thus greatly limiting their use.

### DISCLOSURE OF THE INVENTION

The present invention provides a flexible material for ballistic protection e.g. for use in personal body armor, said material comprising:

a plurality of compact layers (e.g., laminates, mats) of ballistic fiber and

between the layers of ballistic fibers inserted at least one intermediate layer of non-Newtonian (dilatant) fluid exhibiting an increase in viscosity resulting from an increase in shear stress (i.e., a shear thickening material), preferably with a good adhesiveness to ballistic fiber layers, and optionally containing particles having the size of from 1 to 700 nm or antiplasticizing agents, said intermediate layer being inserted either directly between layers of ballistic fiber, or inserted between the layers on a carrier (e.g., a compact or perforated, plastic or fiber carrier).

The carrier may be a plastic film, e.g. polyethylene terephthalate, or a carrier fabric, e.g. made of polyester (PET), polyamide (PA), liquid crystal (commercial Zylon) or polyethylene (UHMWPE). The said carrier fabric is, however, not identical to the compact layer of ballistic fiber. Preferably, the carrier fabric is a nanofiber fabric, i.e., having fibers of the size of the order of units to hundreds nanometers.

The compact layer of ballistic fibers can be made from any type of ballistic fabric. The ballistic fabrics are well known to a skilled person. An example of such material is ultra-high-molecular-weight-polyethylene (UHMWPE) marketed commercially under trademarks such as Dyneema or Spectra. Layers of ballistic fiber made from polyaromatic amide compounds (a commercial example of which is Kevlar) or liquid crystal fibers (e.g., Zylon) may also be utilized.

The present invention thus does not relate to impregnating ballistic fiber. h relates to connecting them by employing an intermediate layer of non-Newtonian fluid, which may be in the form of thermoplastic rubber material applied directly onto the fiber layer surface (thus gluing or bonding the layers) or it may be placed on carriers or perforated carriers, e.g., within a packing or perforated packing. It is therefore unnecessary to stitch the layers together, as they are joined by means of intermediate layers. This enables mutual movement of the layers during bending under normal conditions, thus creating a ballistic protection material with greater flexibility for use in such accessories as personal body armor. When struck with a ballistic projectile however, the material becomes rigid, significantly increasing the thickness of the layers of compact ballistic fiber participating the interception of the missile. The intermediate layer preferably has the thickness of up to 0.5 mm.

Materials having the characteristics of non-Newtonian fluid showing an increase in viscosity resulting from an increase in shear stress are well known. Particularly suitable non-Newtonian fluids are, e.g., oligomeric mixtures based on acrylic monomers containing varying lengths of side chains, polyurethanes based on methylenediphenyl diisocyanate (MDI) and hexamethylene diisocyanate (HDI) with ester or ether polyols, or polyols based on oxidized cellulose derived from styrene-butadiene/polyterpene/dipentene macromonomers. Preferably, thermoplastic polyurethanes, styrene-butadiene rubbers and other linear and lightly cross-linked (0 to 20%) amorphous polymers with a glass transition temperature of less than −40 ° C. may also be utilized to this end. The said fluids may further contain nanoparticles, preferably silicate, cellulose, alumina nanoparticles which can assume any shape, e.g. spherical, needle-shaped, platelet. Suitable filler nanoparticles include pyrolytic and colloidal silica, variants of POSS particles (polyhedral silsesquioxane), laponite, Al₂O₃ particles or whiskers, cellulose whiskers and nanocrystals, particles of ZrO₂, graphene, C60, carbon nanotubes or hybrid combinations of said particles. Preferably, hierarchical submicronic clusters of nanoparticles can also be used. Additionally, antiplasticizers can be used to achieve dilatant behavior in a liquid. Antiplasticizing agents are molecules that lower the mobility of polymer segments during high shear stress. The choice of the antiplasticizer depends on the fluid to be used. Suitable antiplasticizers include chlorinated biphenyls and terphenyls, polystyrene glycols, abietlic acid derivatives, amino and/or carboxyl-terminated oligomeric amides, dimethyl methyl phosphonate, 4-hydroxyacetanilide and 1,2-epoxy-3-phenoxypropane. In order to achieve a minimal surface density, particles and antiplasticizers may be combined.

In a preferred embodiment, a foam layer is placed on the inward facing surface of the material (interception side, i.e., the side facing the protected object, e.g., a body of the wearer of a body armour). The foam layer thus separates the protective material from the body of the wearer so that any deformation caused by projectile impact is be absorbed by the foam layer padding, shielding the protected object, e.g., a person's body. Materials such as polyethylene foam or polyurethane foam may be utilized to this end.

The invention further provides a method for preparation of the material for ballistic protection, wherein at least two compact layers of ballistic fiber are joined by means of at least one intermediate layer of non-Newtonian fluid exhibiting an increase in viscosity resulting from an increase in shear stress, and the resulting material may optionally be connected with further compact layers of ballistic fiber, and in a preferred embodiment, the resulting materials can be provided on one side with a foam layer.

A protective device designed in accordance with this invention is capable of protecting against Type IIIA ballistic threat, as defined by the National Institute of Justice Standard 0101.03. A Type IIIA threat corresponds to a 44 Magnum projectile, having a mass of 15.5 grams and impacting at a velocity of 450 m/s, or a 9 millimeter, full metal jacket round bullet possessing a mass of 8 grams and impacting at a velocity of 450 m/s. Protection against the threat requires that the target be deformed in the direction of projectile movement by no more than 44 millimeters. During the V50 ballistic test, the invention was able to withstand velocities greater than 500 m/s, often greater than 600 m/s where US standards require a minimum of 430 m/s. Hitherto existing products are generally able to defeat a missile traveling at speeds of up to 600 m/s. Furthermore, the new textile possesses 20 to 25% less surface density than current products.

The present invention is particularly well suited for the manufacturing of body armor for military personnel, peace-keeping forces or other individuals who must be protected from death or injury by a ballistic projectile.

### BRIEF DESCRIPTION OF DRAWINGS

FIG. 1. Schematic representation of one embodiment of arrangement of layers of a flexible material for ballistic protection.

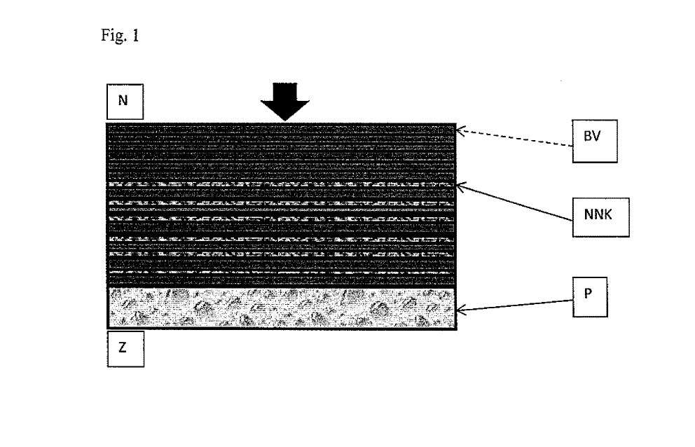

N—ballistic side, Z—interception side (inward facing towards the protected object), BV—compact layer of ballistic fiber from ultra-high-molecular-weight-polyethylene, NNK—layer of shear thickening material (non-Newtonian fluid), P—foam layer in contact with the wearer.

### EXAMPLES OF CARRYING OUT THE INVENTION

### Example 1

### Preparation of Mmaterials for Ballistic Protection

### Material X3M

Three layers of compact ballistic fiber based on ultra-high-molecular-weight-polyethylene (UHMWPE), marketed commercially e.g. under trademarks Dyneema or Spectra (henceforth referred to as mats or laminates) were connected (bonded, glued) together by means of a non-Newtonian shear thickening adhesive on the basis of styrene-butadiene/polyterpene/dipentene with spherical SiO₂ nanoparticles and their clusters. The size of the primary nanoparticles is in the range from 1 to 20 nm, clusters have the size of up to 500 nm. This adhesive formed a thin, even film with a maximum thickness of 0.5 mm. Three mats thus bonded formed a triple-layer.

A total of five triple-layers were used to make the ballistic panel (on the ballistic side), further bolstered by ten additional independent mats. The final layer of the interception side of the panel was padding made of polyethylene foam (PE) serving as an impact absorbing lining.

The resulting material denoted as X3M is well suited for flexible personal body armor.

### Material X2

Three layers of compact ballistic fiber based on ultra-high-molecular-weight-polyethylene (UHMWPE), marketed commercially e.g. under trademarks Dyneema or Spectra (henceforth referred to as mats or laminates) were connected together, thereby creating a triple-layer. The three mats were joined to each other by a polyethylene terephthalate (PET) carrier film carrying a thin layer of shear thickening acrylic monomer-based adhesive with spherical SiO₂ nanoparticles and clusters thereof. The size of the primary nanoparticles is in the range from 1 to 20 nm, clusters have the size of up to 500 nm. This adhesive created a thin, even film with a maximum thickness of 0.5 mm.

A total of ten independent mats reinforced the five triple-layers of this sample's ballistic panel. The final layer of the interception side of the panel was padding made of polyethylene foam (PE) serving as an impact absorbing lining.

The resulting material denoted as X2 is well suited for use as flexible personal body armor.

### Material X2-TOP

Three layers of compact ballistic fiber based on ultra-high-molecular-weight-polyethylene (UHMWPE), marketed commercially e.g. under trademarks Dyneema or Spectra (henceforth referred to as mats or laminates) were connected together, thereby creating a triple-layer. The three mats were joined to each other by a polyethylene terephthalate (PET) carrier film carrying a thin layer of a shear thickening acrylic monomer-based adhesive with spherical SiO₂ nanoparticles and clusters thereof. The size of the primary nanoparticles ranges from 1 to 20 nm, clusters have the size of up to 500 nm. This adhesive formed a thin, even film with a maximum thickness of 0.5 mm.

A total of five triple-layers were used to make the ballistic panel on the ballistic side, further bolstered by ten additional independent mats. The final layer was padding made of polyethylene foam (PE) serving as an impact absorbing lining.

The resulting material denoted as X2-TOP is well suited for use as flexible personal body armor.

### Material X2-M

Three layers of compact ballistic fiber based on ultra-high-molecular-weight-polyethylene (UHMWPE), marketed commercially e.g. under trademarks Dyneema or Spectra (henceforth referred to as mats or laminates) were connected together, thereby creating a triple-layer. The three mats were joined to each other by a polyethylene terephthalate (PET) carrier film carrying a thin layer of a shear thickening acrylic monomer-based adhesive with spherical SiO₂ nanoparticles and clusters thereof. The size of the primary nanoparticles rangew from 1 to 20 nm, clusters have the size of up to 500 nm. This adhesive formed a thin, even film with a maximum thickness of 0.5 mm. This sample comprised a total of five independent mats on the ballistic side and five triple-layers reinforced by an additional five mats to form the ballistic panel. The final layer was padding made of polyethylene foam (PE) serving as an impact absorbing lining.

The resulting material denoted as X2-M is well suited for use as flexible personal body armor.

### Material APU

Three layers of compact ballistic fiber based on ultra-high-molecular-weight-polyethylene (UHMWPE), marketed commercially e.g. under trademarks Dyneema or Spectra (henceforth referred to as mats or laminates) were connected together, thereby creating a triple-layer. The three mats were joined to each other by a polyurethane-based shear thickening adhesive containing needle-shaped and platelet-shaped particles with a smallest dimension of 0.1 to 20 nm and biggest dimension of 10 nm to 1 mm. Cellulose whiskers are an example of a filler of needle-shaped nanoparticles, whereas laponite is an example of a filler of platelet-shaped nanoparticles. This adhesive formed a thin, even film with a maximum thickness of 0.5 mm.

A total of ten independent mats on the ballistic side were further bolstered by five triple-layers to form the ballistic panel in this sample. The final layer was padding made of polyethylene foam (PE) serving as an impact absorbing lining.

### Material APUNS

Three layers of compact ballistic fiber based on ultra-high-molecular-weight-polyethylene (UHMWPE), marketed commercially e.g. under trademarks Dyneema or Spectra (henceforth referred to as mats or laminates) were connected together, thereby creating a triple-layer. The three mats were joined to each other by a polyurethane-based shear thickening adhesive containing 0.1 to 12% w/w silica nanoparticles. This adhesive formed a thin, even film with a maximum thickness of 0.5 mm.

A total of ten independent mats on the ballistic side were further bolstered by five triple-layers to form the ballistic panel in this sample. The final layer was padding made of polyethylene foam (PE) serving as an impact absorbing lining.

### Material APUA

Three layers of compact ballistic fiber based on ultra-high-molecular-weight-polyethylene (UHMWPE), marketed commercially e.g. under trademarks Dyneema or Spectra (henceforth referred to as mats or laminates) were connected together, thereby creating a triple-layer. The three mats were joined to each other by a polyurethane-based shear thickening adhesive containing 12 to 20% w/w alumina nanoparticles. This adhesive formed a thin, even film with a maximum thickness of 0.5 mm.

A total of ten independent mats on the ballistic side were further reinforced by five triple-layers to form the ballistic panel in this sample. The final layer was padding made of polyethylene foam (PE) serving as an impact absorbing lining.

### Material X2-TOP-MOD2

Three layers of compact ballistic fiber based on ultra-high-molecular-weight-polyethylene (UHMWPE), marketed commercially e.g. under trademarks Dyneema or Spectra (henceforth referred to as mats or laminates) were connected together, thereby creating a triple-layer. The three mats were joined to each other by a polyethylene terephthalate (PET) carrier film carrying a thin layer of acrylic monomer-based shear thickening adhesive with spherical SiO₂ nanoparticles and clusters thereof. The size of the primary nanoparticles ranges from 1 to 20 nm, clusters have the size of up to 500 nm. This adhesive formed a thin, even film with a maximum thickness of 0.5 mm.

A total of six triple-layers on the ballistic side were used to make the ballistic panel, further bolstered by ten additional independent mats. The final layer was padding made of polyethylene foam (PE) serving as an impact absorbing lining.

### Example 2

### Ballistic Limit Velocity

The ballistic limit velocity for the prepared individual materials was determined in accordance with NIJ Standard-0101.04 Tests were conducted using 9×19 FMJRN rounds weighing 8 grams, manufactured by S&B Vla\check{s}im. Velocities, whereby full or partial penetration occurred under testing conditions, were evaluated. The result is an arithmetic average of the velocities of 5× full penetration and 5× partial penetration.

| Sample | V50 (m/s) |
|---|---|
| X3M | 642.2 |
| X2 | 577 |
| X2-TOP | 647 |
| X2-M | 625 |
| APU | 594 |
| APUNS | 567 |
| APUA | 562 |
| X2-TOP-MOD2 | 635.1 |

1. A material for ballistic protection, characterized in that it comprises:
a plurality of compact layers of ballistic fiber and
between the layers of ballistic fibers inserted at least one intermediate layer of non-Newtonian fluid exhibiting an increase in viscosity resulting from an increase in shear stress, said intermediate layer being placed either directly between layers of ballistic fiber, or placed between the layers on a carrier or a perforated carrier.

2. The material according to claim 1, wherein the intermediate layer of non-Newtonian fluid contains particles having the size of from 1 to 700 nm and/or antiplasticizing agents.

3. The material according to claim 1, wherein the carrier or the perforated carrier is a plastic film.

4. The material according to claim 1, wherein the carrier or the perforated carrier is a nanofiber fabric.

5. The material according to claim 1, wherein a foam layer is placed on one surface of the material.

6. A method for preparation according to claim 1, characterized in that at least two compact layers of ballistic fiber are joined by means of at least one intermediate layer of non-Newtonian fluid exhibiting an increase in viscosity resulting from an increase in shear stress, and the resulting material may optionally be connected with further compact layers of ballistic fiber.

7. The method according to claim 6, wherein the resulting materials is provided on one side with a foam layer.

8. Use of the material according to claim 1 for bulletproof vests, combat helmets, personal body armor and/or for shielding light infantry and passenger automobiles.
